(19) United States
(12) Patent Application Publication
(10) Pub. No.: US 2007/0093229 A1
(43) Pub. Date: Apr. 26, 2007

(54) Complex RF device and method for manufacturing the same

(76) Inventors: Takehiko Yamakawa, Osaka (JP); Hiroshi Nakatsuka, Osaka (JP); Keiji Onishi, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/580,848

(22) Filed: Oct. 16, 2006

(30) Foreign Application Priority Data
Oct. 20, 2005 (JP) 2005-305484

(51) Int. Cl. H04B 1/06; H04B 1/28

(52) U.S. Cl. 455/333; 455/252.1

(57) ABSTRACT

A complex RF device is provided which is composed of two RF circuits stacked vertically. The complex RF device comprises a substrate, a second RF circuit provided on the substrate, and a first RF circuit which is provided on the second RF circuit and does not require a substrate. The first RF circuit is formed on another substrate before being transferred onto the second RF circuit.

### BACKGROUND OF THE INVENTION

1. Field of the Invention

The present invention relates to discrete radio frequency circuit devices (hereinafter referred to as RF devices), such as a filter, a duplexer, a switch (SW), a low noise amplifier (LNA), a power amplifier (PA), and the like, which are used in mobile communication radio circuits, such as mobile telephones, wireless LAN, and the like, or a complex RF device composed thereof, and a method for manufacturing the complex RF device.

2. Description of the Background Art

Mobile apparatuses and the like require smaller-size and lower-profile radio circuits. To this end, regarding filters and radio ICs which are incorporated into electronic apparatuses (e.g., mobile apparatuses, etc.), there is an active trend toward a complex device in which different devices are integrated together so as to achieve a small size.

FIG. 7 is a cross-sectional view of a structure of a complex RF device employing a conventional IC chip. See, for example, Japanese Patent Laid-Open Publication No. H05-13663.

A first IC chip 901 is provided on a second IC chip 902 by face-up mounting. The second IC chip 902 is provided on a substrate 903 made of a ceramic or a resin by face-up mounting. An electrode 904 provided on the first IC chip 901 is connected to an electrode 906 provided on the substrate 903 by wire bonding, so that the first IC chip 901 and the substrate 903 are electrically connected together. An electrode 905 provided on the second IC chip 902 is connected to the electrode 906 provided on the substrate 903 by wire bonding, so that the second IC chip 902 and the substrate 903 are electrically connected together. With this structure, a complex RF device having each of the functions of the first IC chip 901 and the second IC chip 902 is achieved with a small area.

However, in the structure of this conventional complex RF device, the first IC chip 901, the second IC chip 902, and the substrate 903 each have a thickness of several hundreds of micrometers, and therefore, when they are mounted in a stacked manner, the whole complex RF device has a large thickness. Therefore, a technique for reducing the thickness of the whole complex RF device has been proposed.

FIG. 8 is a cross-sectional view of a structure of a conventional complex RF device which employs a piezoelectric filter and solves the above-described problem. See, for example, P. Ancey (ST Microelectronics), “BAW & MEMS above silicon for RF applications”, IEEE MTT-S 2005 International Microwave Symposium Workshop.

An electrode 1002 provided inside and on a surface of a substrate is used to form an IC substrate 1001 having functions of a switch, a low noise amplifier, a power amplifier or the like. On the IC substrate 1001, an insulator element 1004, a lower electrode 1005, a piezoelectric element 1006, and an upper electrode 1007 are stacked in this order via a cavity 1003 to form a piezoelectric resonator 1008. A plurality of piezoelectric resonators 1008 are combined to operate as a piezoelectric filter. The IC substrate 1002 and the piezoelectric filter are connected together to form a complex RF device.

With this structure, although the IC substrate 1001 still has a thickness of several hundreds of micrometers, the piezoelectric resonator 1008 has a thickness of about 10 micrometers or less (in a microwave region which is used for mobile telephones or the like, though also depending on the resonance frequency), so that a complex RF device in which a piezoelectric filter having a small thickness is stacked can be achieved.

However, in the conventional structure of FIG. 8, the electrode 1002, the insulator 1004, and a sacrifice layer so as to form the cavity 1003 and the like need to be successively deposited on the IC substrate 1001. Therefore, the evenness of a surface of the IC substrate 1001 is deteriorated before the lower electrode 1005, the piezoelectric element 1006, and the upper electrode 1007 are deposited, so that the crystallinity of the lower electrode 1005, the piezoelectric element 1006, and the upper electrode 1007, which are formed as thin films, is impaired. This reduces a Q value indicating the performance of the piezoelectric resonator 1008, leading to an increase in insertion loss of the piezoelectric filter.

### SUMMARY OF THE INVENTION

Therefore, an object of the present invention is to provide a small-size and low-profile complex RF device having a plurality of functions in a high-quality state without impairing the crystallinity of a piezoelectric layer thereof.

The present invention provides a complex RF device composed of two RF circuits stacked vertically, comprising a substrate, a second RF circuit provided on the substrate, and a first RF circuit provided on the second RF circuit, the first RF circuit not requiring a substrate. The first RF circuit is formed on another substrate before being transferred onto the second RF circuit.

The first RF circuit and the second RF circuit may be electrically connected to each other via first and second support members.

Typically, the first RF circuit is one selected from the group consisting of a piezoelectric resonator, a piezoelectric switch, a piezoelectric filter, and a duplexer which do not require a substrate, and the second RF circuit is one selected from the group consisting of a power amplifier, a switch, an LNA, and an RF-IC which do require a substrate.

Note that the complex RF device functions singly, and may be incorporated into a filter, a duplexer, and a communication apparatus.

The complex RF device is manufactured by the steps of forming a first RF circuit on a first substrate, forming a first support member on the first substrate, forming a second RF circuit on a second substrate, forming a second support member on the second substrate, bonding the first support member and the second support member together, and after the bonding step, removing the first substrate, and transferring the first RF circuit onto the second RF circuit.

Typically, after the transferring step, a predetermined electrode is formed on the first RF circuit.

Preferably, the first and second support members are made of a metal material which can electrically connect the first RF circuit and the second RF circuit together.

According to the present invention, it is possible to provide a small-size and low-profile complex RF device having a plurality of functions in a high-quality state without impairing the crystallinity of a piezoelectric layer thereof.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view illustrating a structure of a complex RF device according to an embodiment of the present invention;

FIG. 2 is a cross-sectional view of the complex RF device, taken along line A-A of FIG. 1;

FIG. 3 is an equivalent circuit diagram of the complex RF device of FIG. 1;

FIGS. 4A to 4D are cross-sectional views illustrating exemplary structures of other complex RF devices which can be achieved by the present invention;

FIGS. 5A and 5B are diagram roughly illustrating a method for manufacturing a complex RF device of the embodiment of the present invention;

FIG. 6 is a diagram illustrating an exemplary configuration of a communication apparatus employing a complex RF device of the embodiment of the present invention; and

FIGS. 7 and 8 are cross-sectional views of a structure of a conventional complex RF device.

### DESCRIPTION OF THE PREFERRED EMBODIMENTS

Hereinafter, embodiments of the present invention will be described with reference to the accompanying drawings.

### Exemplary Structure of Complex RF Device

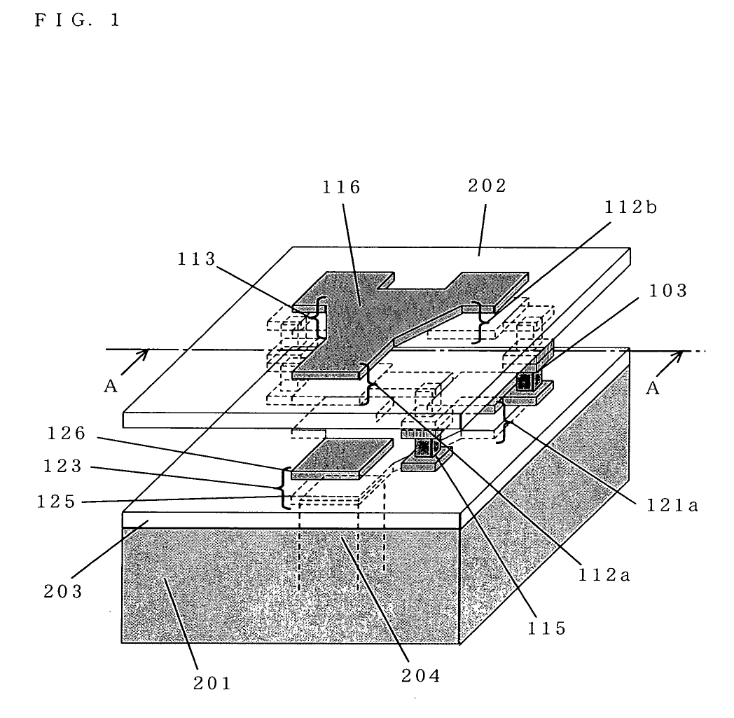

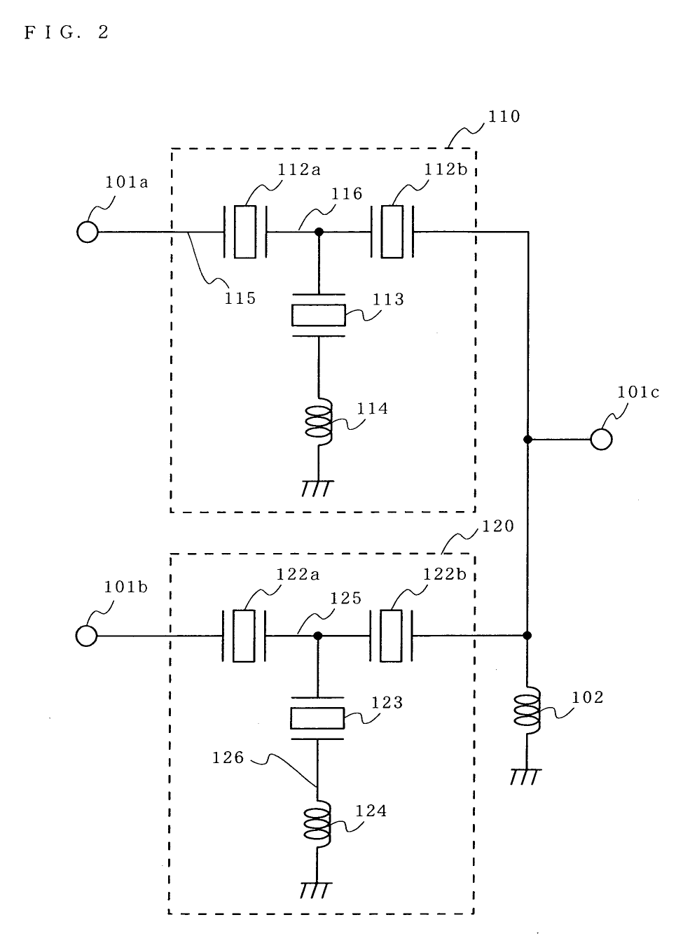

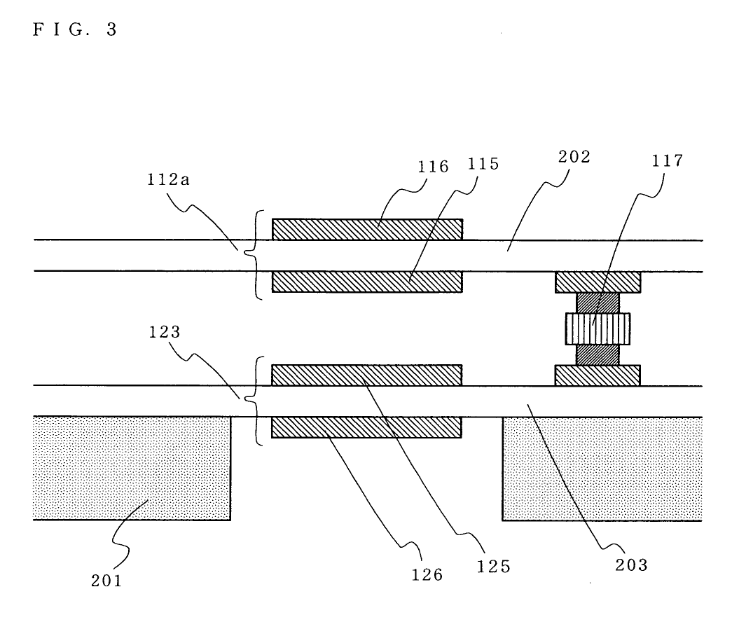

FIG. 1 is a perspective view illustrating a structure of a complex RF device according to an embodiment of the present invention. FIG. 2 is a cross-sectional view of the complex RF device, taken along line A-A of FIG. 1. FIG. 3 is an equivalent circuit diagram of the complex RF device of FIG. 1. In FIGS. 1 to 3, a duplexer employing a piezoelectric filter is illustrated as an example of the complex RF device.

The complex RF device of this embodiment has a transmission terminal 101a, a reception terminal 101b, and an antenna terminal 101c, and is composed of a transmission filter 110 connected to the transmission terminal 101a, a reception filter 120 connected to the reception terminal 101b, and a phase-shift circuit 102 provided between the transmission filter 110 and the reception filter 120, and the antenna terminal 101c. As illustrated in FIG. 1, the complex RF device has a structure in which the transmission filter 110 (first RF circuit) is provided at an upper portion thereof and the reception filter 120 (second RF circuit) is provided at a lower portion thereof.

Referring to FIG. 2, the transmission filter 110 is composed of piezoelectric resonators 112a and 112b connected in series between the transmission terminal 101a and the antenna terminal 101c, a piezoelectric resonator 113 connected in parallel therebetween, and an inductor 114 via which the piezoelectric resonator 113 is grounded. The reception filter 120 is composed of piezoelectric resonators 122a and 122b connected in series between the reception terminal 101b and the antenna terminal 101c, a piezoelectric resonator 123 connected in parallel therebetween, and an inductor 124 via which the piezoelectric resonator 123 is grounded. In the example of FIG. 2, as the phase-shift circuit 102, an inductor via which a connection point of the transmission filter 110 and the reception filter 120 is grounded, is employed.

Note that the above-described circuit configurations of the transmission filter 110 and the reception filter 120 are only for illustrative purposes, and a similar effect can be obtained when other numbers of stages or other circuit configurations are employed. Also, the phase-shift circuit 102 may have other circuit configurations, depending on transmission/reception intervals or the impedances of the transmission filter 110 and the reception filter 120.

Referring to the cross-sectional view of FIG. 3, in the complex RF device of this embodiment, the piezoelectric resonator 123 which belongs to the second RF circuit and is composed of an upper electrode 125, a lower electrode 126, and a piezoelectric element 203, is formed on a substrate 201 made of GaAs or the like. On the piezoelectric resonator 123, the piezoelectric resonator 112a which belongs to the first RF circuit and is composed of an upper electrode 115, a lower electrode 116, and a piezoelectric element 202, is formed. The first RF circuit is formed via a metal column 117 made of a gold-tin alloy or the like above the second RF circuit so that a manufacturing method described below can be used. Note that the shape of the metal column 117 is not limited to that of FIG. 3.

Thus, in the present invention, parts requiring a substrate, such as a power amplifier, a switch, an LNA, or an RF-IC, or the like, are formed in the lower second RF circuit, and parts not requiring a substrate, such as a piezoelectric resonator, a MEMS switch, or a piezoelectric filter or a duplexer employing these, or the like, are formed on the upper first RF circuit.

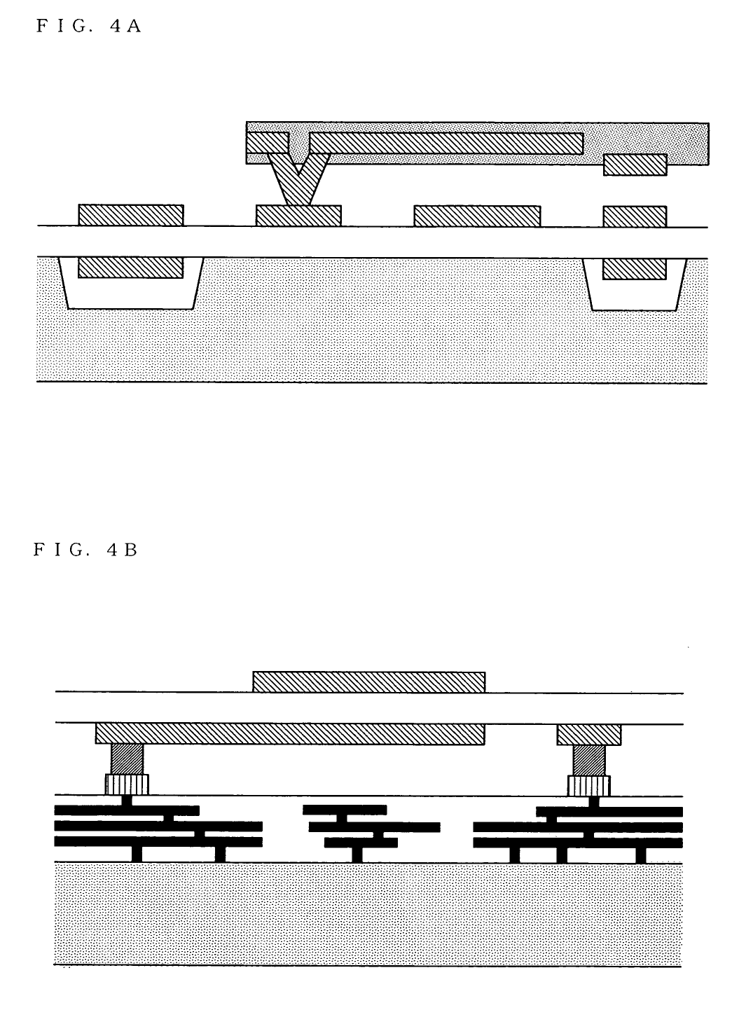

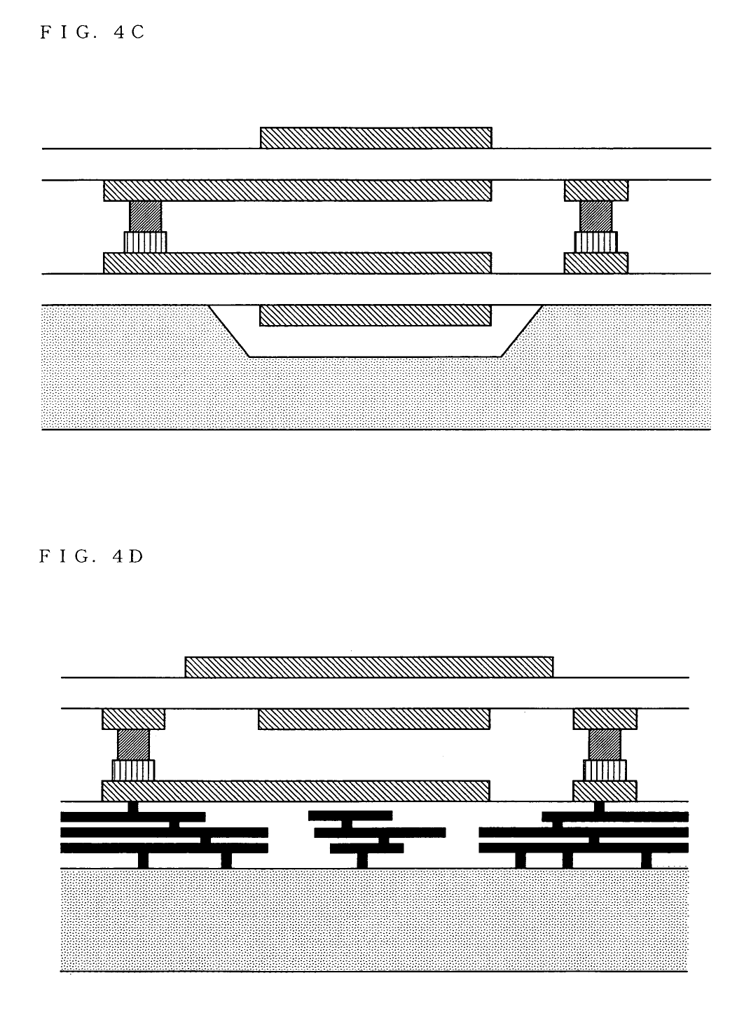

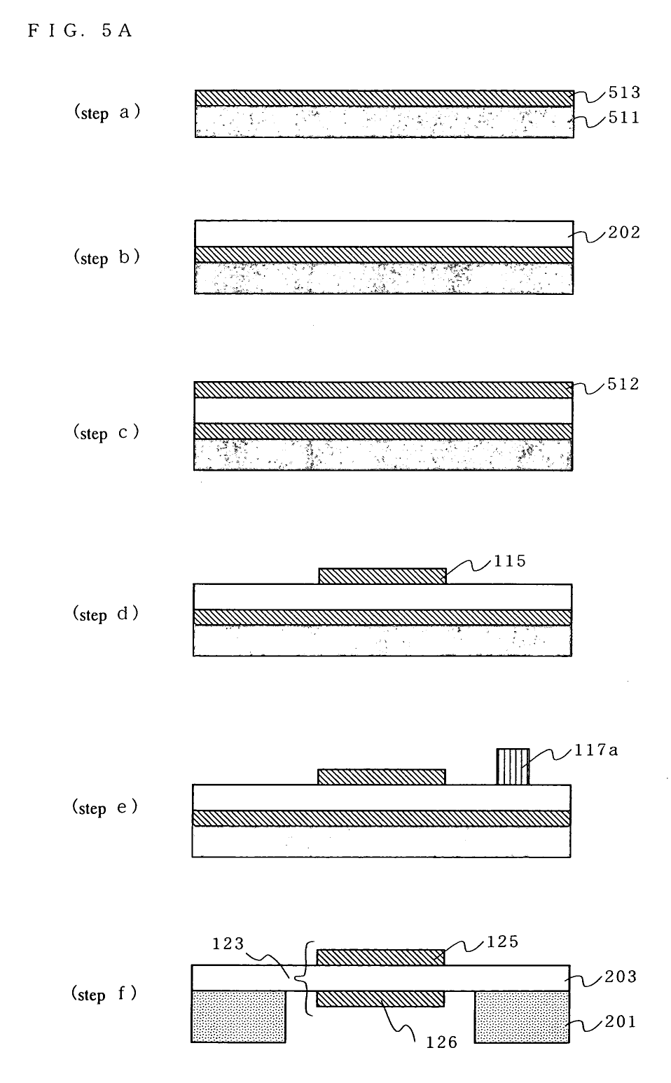

FIGS. 4A to 4D are cross-sectional views illustrating exemplary structures of other complex RF devices which can be achieved by the present invention. FIG. 4A illustrates an exemplary structure of a complex RF device in which a cantilever MEMS switch is provided in the first RF circuit and a piezoelectric resonator is provided in the second RF circuit. FIG. 4B illustrates an exemplary structure of a complex RF device in which a duplexer employing a piezoelectric filter is provided in the first RF circuit and a power amplifier is provided in the second RF circuit. FIG. 4C illustrates an exemplary structure of a complex RF device in which a duplexer employing a piezoelectric filter is provided in the first RF circuit and a piezoelectric filter is provided in the second RF circuit. FIG. 4D illustrates an exemplary structure of a complex RF device in which a piezoelectric switch is provided in the first RF circuit and a power amplifier is provided in the second RF circuit.

### Exemplary Method for Manufacturing Complex RF Device

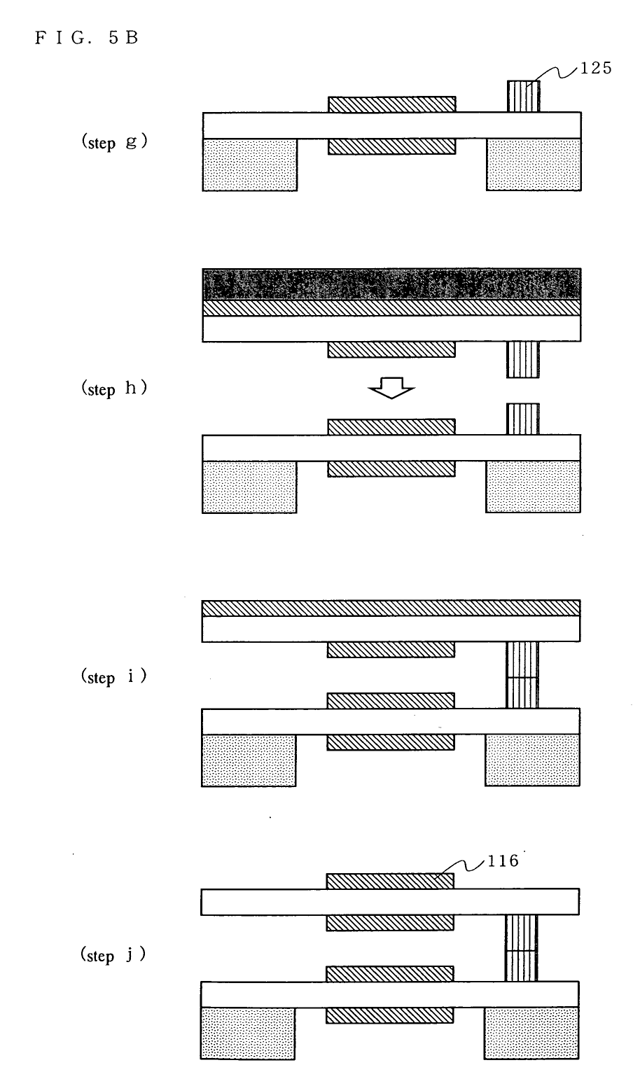

FIGS. 5A and 5B are diagram roughly illustrating a method for manufacturing a complex RF device of this embodiment. In this manufacturing method, the complex RF device of FIG. 3 is manufactured by a wafer-to-wafer bonding method.

Initially, a film-formation substrate 511 made of silicon, glass, sapphire or the like is prepared. An electrode film 513 made of molybdenum (Mo) or the like is formed on the film-formation substrate 511 (step a of FIG. 5A). Note that an even thermal oxide film (not shown) is previously formed as an insulating film on the film-formation substrate 511. Next, a piezoelectric layer 202 made of aluminum nitride (AlN) or the like is formed on the electrode film 513 (step b of FIG. 5A). For example, when a piezoelectric resonator having a 2-GHz band is formed, the piezoelectric layer 202 is designed to have a thickness of about 1100 nm, and the electrode film 513 is designed to have a thickness of about 300 nm. In this example, the piezoelectric layer 202 is formed via the electrode film 513 on the even film-formation substrate 511, there is not an influence of a discontinuity occurring in the electrode film 513, a degradation in a surface of the electrode film 513 occurring when during patterning, or the like, thereby making it possible to obtain the piezoelectric layer 202 having a satisfactory level of crystallinity.

Next, an electrode film 512 made of molybdenum or the like is formed on the piezoelectric layer 202 (step c of FIG. 5A). Thereafter, the electrode film 512 is patterned into a predetermined shape by typical photolithography to form a lower electrode 115 (step d of FIG. 5A). Next, a support member 117a which is to be a part of the support portion 117 is formed on the piezoelectric layer 202 by electron beam vapor deposition, sputtering, or the like (step e of FIG. 5A). In this example, the support member 117a is formed by electron beam vapor deposition of Ti/Au/AuSn in this order using a lift-off technique. Thereby, preparation of the film-formation substrate 511 is completed.

Next, the substrate 201 is prepared, and the piezoelectric resonator 123 composed of the upper electrode 125, the lower electrode 126 and the piezoelectric layer 203 is formed in a similar manner (step f of FIG. 5A). Note that an even thermal oxide film or the like (not shown) is previously formed as an insulating film on the substrate 201. Next, a support member 117b which is to be a part of the support portion 117 is formed on the piezoelectric layer 203 by electron beam vapor deposition, sputtering, or the like (step g of FIG. 5B). In this example, the support member 117b is formed by electron beam vapor deposition of Ti/Au/AuSn in this order using a lift-off technique so that, when the substrate 201 is disposed, facing the film-formation substrate 511, the AuSn alloy layer of the support member 117b contacts the AuSn alloy layer of the support member 117a. Note that the pattern of the support member 117b formed on the substrate 201 does not need to completely match the pattern of the support member 117a formed on the film-formation substrate 511, and a margin is preferably provided in view of the accuracy of positioning both the substrates.

Next, the support member 117a of the film-formation substrate 511 and the support member 117b of the substrate 201 are caused to face each other, and are bonded together by eutectic crystallization of gold and tin (step h of FIG. 5B). In this case, a pressure is applied to both the substrates. In this example, a press pressure of three atmospheres is applied so as to bond the substrates. Also, the bonded substrates are heated, so that AuSn contacting each other are melted, and thereafter, by reducing the temperature, firm metal bond can be obtained. Thereby, a piezoelectric resonator having an excellent level of reliability of bonding can be obtained.

Although a AuSn alloy is used in the support portion 117 in this example, the present invention is not limited to this. For example, when the two substrates are bonded together via a half-melted or melted state of the support portion 117, the melting point (solidus temperature) may be higher than solder reflow temperature at which the piezoelectric resonator is mounted on a mother board, and may be lower than the melting points of an electrode material and the like of the piezoelectric resonator. Also, the support portion 117 may be bonded by diffusion bonding due to mutual diffusion of metals below the melting point, or alternatively, may be bonded at room temperature by surface activation of bonding surfaces using a plasma treatment or the like. By room-temperature bonding, residual thermal stress can be eliminated from the vibrating portion, thereby making it possible to obtain a piezoelectric resonator having a high manufacturing yield and a small change over time in frequency fluctuation or the like.

Next, the film-formation substrate 511 is removed from the product obtained by bonding the two substrates together (step i of FIG. 5B). For example, the film-formation substrate 511 can be removed by dry etching. By steps g to i, the first RF circuit which is originally present on the film-formation substrate 511 is transferred to the substrate 201 on which the second RF circuit is formed. Finally, the electrode film 513 is patterned into a predetermined shape by typical photolithography to form an upper electrode 116 (step j of FIG. 5B). Thereby, the complex RF device of FIG. 3 is completed.

Although the film-formation substrate 511 is removed by, for example, etching in the above-described manufacturing method, a come-off layer may be provided between the electrode film 513 and the film-formation substrate 511 so that the film-formation substrate 511 can be detached along with the come-off layer. Alternatively, the electrode film 513 may not be formed, and a come-off layer and the piezoelectric layer 202 may be stacked on the film-formation substrate 511. In this case, after the film-formation substrate 511 is detached, the upper electrode 116 needs to be formed by patterning. When gallium nitride (GaN), which has optical characteristics different from those of AlN, is used as the come-off layer, AlN can be transferred by decomposing only GaN by irradiation with laser. Alternatively, as the come-off layer, a metal film which has a small affinity with the electrode film 513, a metal film or an oxide substance which is dissolved in a solvent or the like, glass, or the like may be used.

As described above, according to the embodiment of the present invention, a small-size and low-profile complex RF device having a plurality of functions can be achieved in a high-quality state without impairing the crystallinity of the piezoelectric layer.

### Exemplary Configuration Employing Complex RF Device

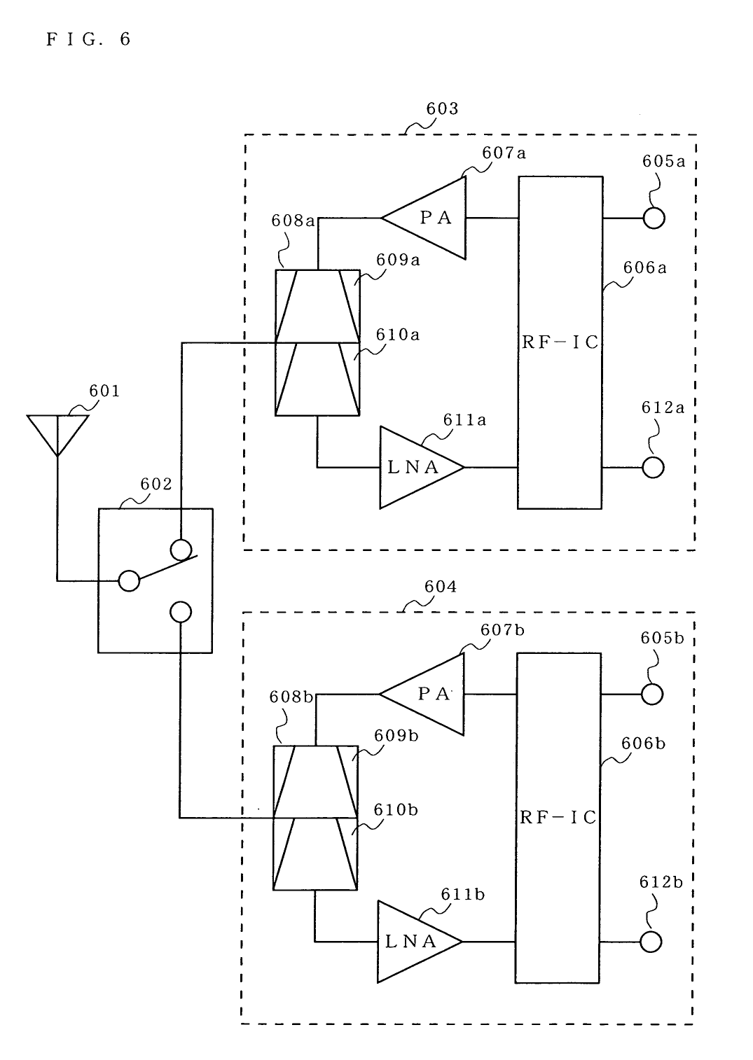

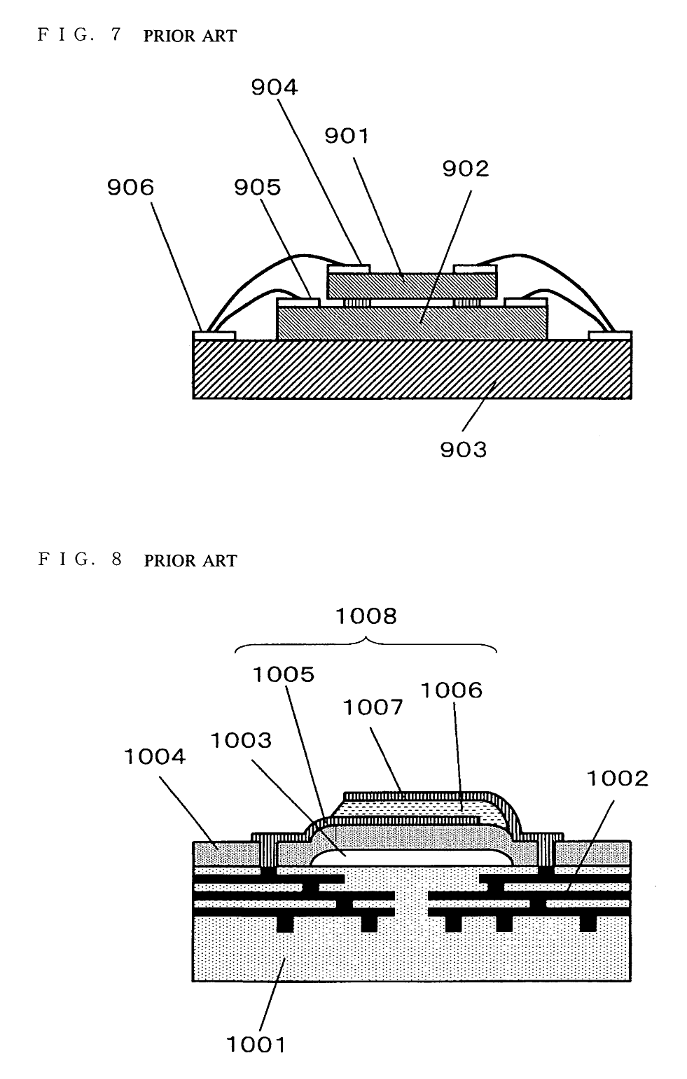

FIG. 6 is a diagram illustrating an exemplary configuration of a communication apparatus employing a complex RF device of the present invention. In the communication apparatus of FIG. 6, two transmission/reception circuits 603 and 604 are connected and switched by a switch 602 so as to support a plurality of bands.

A signal input through an antenna 601 is separated and input by the switch 602 into the first transmission/reception circuit 603 which is operated at a low frequency band (first band) and the second transmission/reception circuit 604 which is operated at a high frequency band (second band). In the first transmission/reception circuit 603, a first-band transmission signal input through a transmission terminal 605a is passed through an RF-IC 606a, a power amplifier 607a, and a transmission filter 609a of a duplexer 608a, and is transmitted via the switch 602 from the antenna 601. Also, a first-band reception signal input through the antenna 601 is passed and transferred through the switch 602, a reception filter 610a of the duplexer 608a, an LNA 611a, and the RF-IC 606a, to a reception terminal 612a.

Similarly, in the second-band transmission/reception circuit 604, a second-band transmission signal input through a transmission terminal 605b is passed through an RF-IC 606b, a power amplifier 607b, and a transmission filter 609b of a duplexer 608b, and is transmitted via the switch 602 from the antenna 601. Also, a second-band reception signal input through the antenna 601 is passed and transferred through the switch 602, a reception filter 610b of the duplexer 608b, an LNA 611b, and the RF-IC 606b, to a reception terminal 612b. With this configuration, a communication apparatus which has low loss and low power consumption can be achieved.

While the invention has been described in detail, the foregoing description is in all aspects illustrative and not restrictive. It is understood that numerous other modifications and variations can be devised without departing from the scope of the invention.

What is claimed is:

1. A complex RF device composed of two RF circuits stacked vertically, comprising:
a substrate;
a second RF circuit provided on the substrate; and
a first RF circuit provided on the second RF circuit, the first RF circuit not requiring a substrate,
wherein the first RF circuit is formed on another substrate before being transferred onto the second RF circuit.

2. The complex RF device according to claim 1, wherein the first RF circuit and the second RF circuit are electrically connected to each other via first and second support members.

3. The complex RF device according to claim 1, wherein
the first RF circuit is one selected from the group consisting of a piezoelectric resonator, a piezoelectric switch, a piezoelectric filter, and a duplexer which do not require a substrate, and
the second RF circuit is one selected from the group consisting of a power amplifier, a switch, an LNA, and an RF-IC which do require a substrate.

4. A filter comprising at least one complex RF device according to claim 1.

5. A duplexer comprising at least one complex RF device according to claim 1.

6. A communication apparatus comprising at least one complex RF device according to claim 1.

7. A method for manufacturing a complex RF device, comprising the steps of:
forming a first RF circuit on a first substrate;
forming a first support member on the first substrate;
forming a second RF circuit on a second substrate;
forming a second support member on the second substrate;
bonding the first support member and the second support member together; and
after the bonding step, removing the first substrate, and transferring the first RF circuit onto the second RF circuit.

8. The method according to claim 7, further comprising:
after the transferring step, forming a predetermined electrode on the first RF circuit.

9. The method according to claim 7, wherein the first and second support members are made of a metal material which can electrically connect the first RF circuit and the second RF circuit together.

10. The method according to claim 7, wherein
the first RF circuit is one selected from the group consisting of a piezoelectric resonator, a piezoelectric switch, a piezoelectric filter, and a duplexer which do not require a substrate, and
the second RF circuit is one selected from the group consisting of a power amplifier, a switch, an LNA, and an RF-IC which do require a substrate.
